(19) United States
(12) Patent Application Publication
(10) Pub. No.: US 2019/0113668 A1
(43) Pub. Date: Apr. 18, 2019

(54) SUBSTRATE, DISPLAY DEVICE AND METHOD FOR MANUFACTURING THE SUBSTRATE

(71) Applicant: BOE TECHNOLOGY GROUP CO., LTD., Beijing (CN)

(72) Inventors: Yingtao WANG, Beijing (CN); Jikai YAO, Beijing (CN); Feng GUAN, Beijing (CN); Tingting ZHOU, Beijing (CN); Xiaolong HE, Beijing (CN)

(73) Assignee: BOE TECHNOLOGY GROUP CO., LTD., Beijing (CN)

(21) Appl. No.: 15/567,150

(22) PCT Filed: Apr. 27, 2017
(86) PCT No.: PCT/CN2017/082179

§ 371 Date: Oct. 17, 2017

(30) Foreign Application Priority Data
Jun. 27, 2016 (CN) 201610482047.5

(51) Int. Cl. G02B 5/30; G02F 1/1335

(52) U.S. Cl. CPC G02B 5/3058; G02F 1/133528; G02F 2201/56; G02F 2001/133548; G02F 1/133514

(57) ABSTRACT

A substrate, a display device and a method for manufacturing the substrate are provided. The substrate includes a base substrate and a wire grid array formed on the base substrate, wherein the wire grid array comprises a plurality of metal patterns arranged in sequence, and a width of a side of each of the metal patterns away from the base substrate is smaller than a width of a side of the metal pattern close to the base substrate.

### CROSS-REFERENCE TO RELATED APPLICATIONS

This application is the U.S. national phase of PCT Application No. PCT/CN2017/082179 filed on Apr. 27, 2017, which claims priority to Chinese Patent Application No. 201610482047.5 filed on Jun. 27, 2016, which are incorporated herein by reference in their entireties.

### TECHNICAL FIELD

The present disclosure relates to the field of display technology, and more particularly to a substrate, a display device and a method for manufacturing the substrate.

### BACKGROUND

Display panel manufacturers are striving to meet consumers' higher and higher demands for display products, such as a high transmittance, a low power consumption, and a thin and light design. At present, such demands may be satisfied by using wire grid polarizer (WGP) technology. Since the WGP may be arranged inside a liquid crystal cell, a polarizer may be saved to reduce a thickness of a display panel. In addition, the WGP may serve as an advanced polarizer film (APF) on a lower substrate because of a reflective function of the WGP. As a result, a transmittance of the display panel may be increased, such that a brightness of a backlight source is reduced to realize a low power consumption. However, a WGP structure of a display in the related art leads to a problem of low transmittance and high power consumption of the display product.

### SUMMARY

An object of the present disclosure is to provide a substrate, a display device and a method for manufacturing the substrate, so as to obtain a display product with high transmittance and high contrast, and solve the problem in the relate art where the display product has the low transmittance and the high power consumption.

The technical solutions provided by the present disclosure are as follows.

In one aspect, the present disclosure provides in some embodiments a substrate, including a base substrate and a wire grid array formed on the base substrate, wherein the wire grid array includes a plurality of metal patterns, and a width of a side of each of the metal patterns away from the base substrate is smaller than a width of a side of the metal pattern close to the base substrate.

Furthermore, a width of the metal pattern gradually increases from the side of the metal pattern away from the base substrate to the side of the metal pattern close to the base substrate.

Furthermore, a shape of a cross section of the metal pattern perpendicular to an extending direction of the metal pattern is a trapezoid, the side of the metal pattern away from the base substrate forms a top line of the trapezoid, and the side of the metal pattern close to the base substrate forms a base line of the trapezoid.

Furthermore, the trapezoid is an isosceles trapezoid.

Furthermore, a length of the top line of the trapezoid is half of a length of the base line of the trapezoid.

Furthermore, a shape of a cross section of the metal pattern perpendicular to an extending direction of the metal pattern is a triangle, the side of the metal pattern away from the base substrate forms a vertex of the triangle, and the side of the metal pattern close to the base substrate forms a base of the triangle.

Furthermore, the triangle is an isosceles triangle.

Furthermore, the width of the side of the metal pattern close to the base substrate is in a range of 30 nm to 100 nm, and the metal patterns are spaced apart from each other at a distance in a range of 60 nm to 200 nm.

Furthermore, the substrate is an array substrate or a color filter substrate.

In another aspect, the present disclosure provides in some embodiments a display device including the above substrate.

Furthermore, the substrate of the display device is an array substrate.

In yet another aspect, the present disclosure provides in some embodiments a method for manufacturing the above substrate, including: forming the wire grid array including the plurality of metal patterns on the base substrate, wherein the width of the side of each of the metal patterns away from the base substrate is smaller than the width of the side of the metal pattern close to the base substrate.

Furthermore, forming the wire grid array including the plurality of metal patterns on the base substrate includes: forming a metal layer on the base substrate; coating the metal layer of the base substrate with photoresist, exposing and developing the photoresist by using a mask, to form a photoresist-reserved region corresponding to the metal patterns and a photoresist-unreserved region corresponding to other regions; and forming the wire grid array including the plurality of metal patterns in a dry etching process, wherein during the dry etching process, a composition of etching gas being adjusted in a predetermined manner to control a speed of dry etching, to enable that the width of the side of each of the formed metal patterns away from the base substrate is smaller than the width of the side of the metal pattern close to the base substrate.

Furthermore, during the dry etching process, the composition of the etching gas being adjusted in the predetermined manner to control the speed of the dry etching to enable that the width of the side of each of the formed metal patterns away from the base substrate is smaller than the width of the side of the metal pattern close to the base substrate includes: at the beginning of the dry etching process, increasing an effective dry etching gas composition in the etching gas to subject the metal layer to a quick dry etching process, and then reducing the effective dry etching gas composition in the etching gas in the predetermined manner to subject the metal layer to a slow dry etching process, to obtain the metal patterns.

### BRIEF DESCRIPTION OF THE DRAWINGS

In order to make the technical solutions in embodiments of the present disclosure more apparent, drawings need to be used in the embodiments will be briefly described hereinafter. Obviously, drawings in the following descriptions are merely some of the embodiments of the present disclosure, and based on these drawings, a person skilled in the art may obtain other drawings without any creative labors. The described drawings are not necessarily drawn to scales respect to actual sizes and are merely for illustration purposes only.

FIG. 1 is a schematic view showing a structure of a wire grid array on a display substrate;

FIG. 2 is a schematic view showing a structure of a wire grid array of a substrate in some embodiments of the present disclosure;

FIG. 3 is a schematic view showing a structure of a wire grid array of a substrate in some embodiments of the present disclosure;

FIG. 4 is a schematic view showing formation of photoresist in a method for manufacturing the substrate in some embodiments of the present disclosure;

FIG. 5 is a schematic view showing a structure of a display device in some embodiments of the present disclosure;

FIG. 6 is a flowchart showing the method for manufacturing the substrate in some embodiments of the present disclosure;

FIG. 7 is a flowchart showing a method for forming the wire grid array on the base substrate in some embodiments of the present disclosure; and

FIG. 8 is a flowchart showing a method for controlling a speed of dry etching during a dry etching process in some embodiments of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person skilled in the art. Such words as “first” and “second” used in the specification and claims are merely used to differentiate different components rather than to represent any order, number or importance. Similarly, such words as “one” or “a” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

As shown in FIG. 1, a typical structure of a WGP of a display device is as follows. Taking an array substrate as an example, a wire grid array 20 is formed on a base substrate 10, the wire grid array includes a plurality of metal patterns arranged in sequence, and a cross section of each of the metal patterns is of a rectangle.

The present disclosure provides in some embodiments a substrate capable of obtaining the display product with the high transmittance and the high contrast, and solve the problem in the relate art where the display product has the low transmittance and the high power consumption.

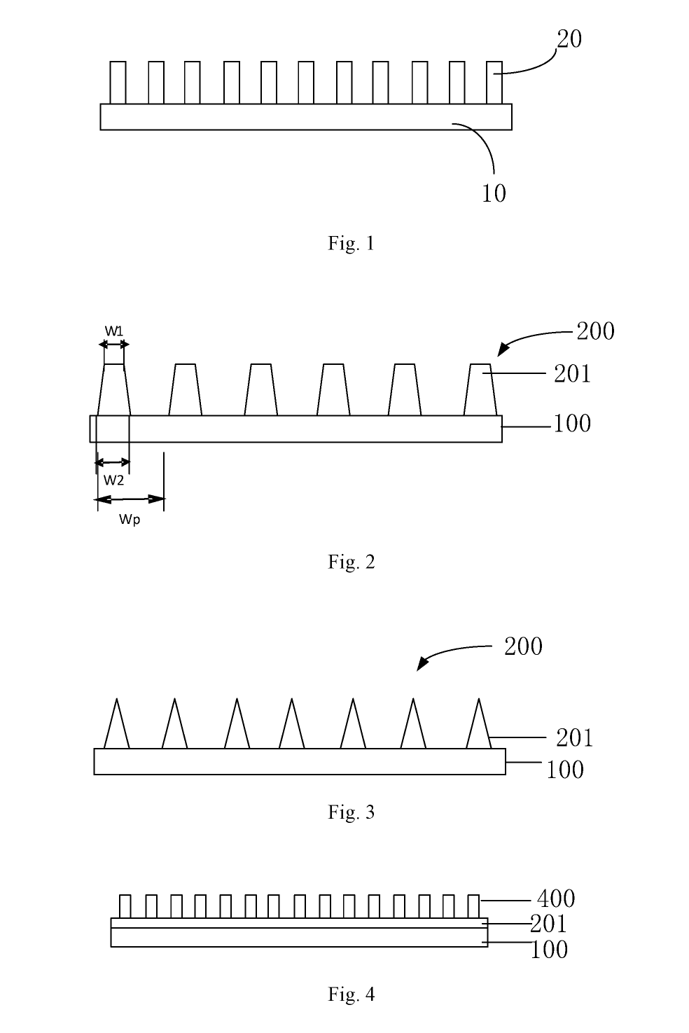

In some embodiments of the present disclosure, as shown in FIGS. 2 and 3, the substrate includes a base substrate 100 and a wire grid array 200 formed on the base substrate 100, the wire grid array 200 includes a plurality of metal patterns 201 arranged in sequence, a width W1 of a side of each of the metal patterns 201 away from the base substrate 100 is smaller than a width W2 of a side of each of the metal patterns 201 close to the base substrate 100.

In the above solution, the shape of each of the metal patterns 201 in the wire grid array 200 is improved, such that the width W1 of the side of each of the metal patterns 201 away from the base substrate 100 is smaller than the width W2 of the side of each of the metal patterns 201 close to the base substrate 100. As compared to the cross section of each of the metal patterns 201 being of the rectangle, the wire grid array of the present disclosure has better transmittance and better degree of polarization, and is capable of obtaining the display product with the high transmittance and the high contrast, and solving the problem in the relate art where the display product has the low transmittance and the high power consumption.

Optionally, in some embodiments of the present disclosure, as shown in FIG. 2 and FIG. 3, a width of the metal pattern 201 gradually increases from the side of the metal pattern 201 away from the base substrate 100 to a width W2 of the side of the metal pattern 201 close to the base substrate 100. By adopting the above solution, the transmittance and the degree of polarization of the WGP may be further increased.

Optionally, in some embodiments of the present disclosure, the width W2 of the side of the metal pattern 201 close to the base substrate 100 is in a range of 30 nm to 100 nm, and the metal patterns are spaced apart from each other at a distance Wp in a range of 60 nm to 200 nm.

It should be noted that, in some embodiments of the present disclosure, the substrate may be an array substrate or a color filter substrate.

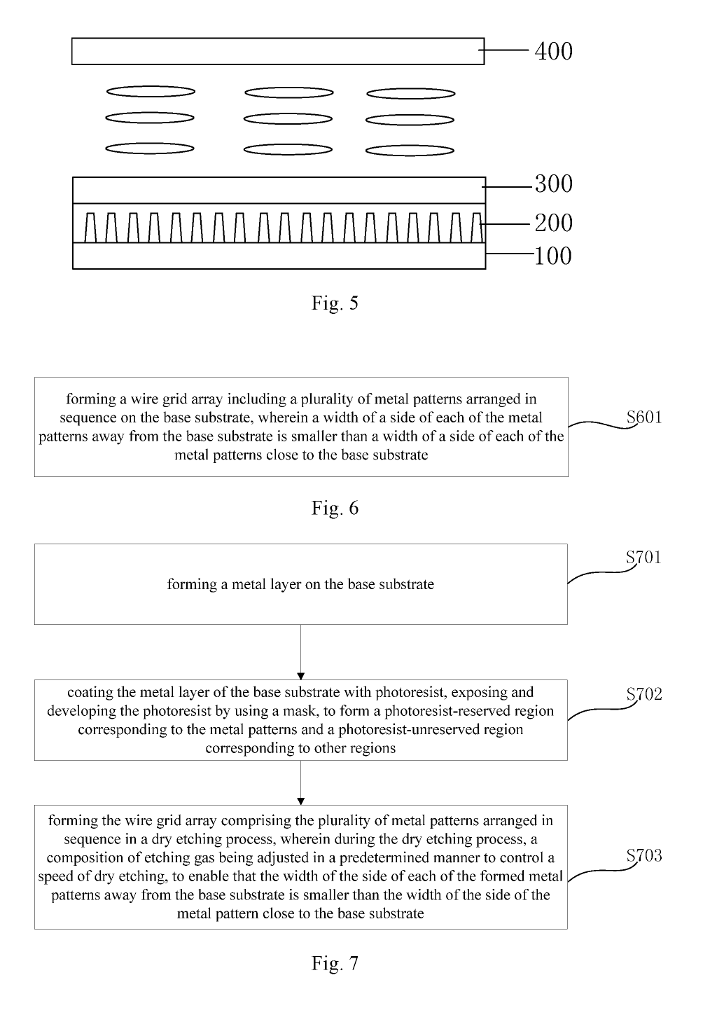

In some embodiments of the present disclosure, taking an array substrate as an example, as shown in FIG. 5, the array substrate may include: the base substrate 100, the wire grid array 200 formed on the base substrate 100 and an array layer 300 formed on the wire grid array, and the array layer 300 includes common electrodes, pixel electrodes, and etc.

In some embodiments, as shown in FIG. 2, a shape of a cross section of the metal pattern 201 perpendicular to an extending direction of the metal pattern 201 is a trapezoid, the side of the metal pattern 201 away from the base substrate 100 forms a top line of the trapezoid, and the side of the metal pattern 201 close to the base substrate 100 forms a base line of the trapezoid. Optionally, the trapezoid is an isosceles trapezoid.

In this embodiment, the cross section of the metal pattern 201 is of a trapezoid, and the wire grid array of the present disclosure has better transmittance as compared to the wire grid array including the metal patterns 201 each being of a rectangle.

In addition, in this embodiment, a simulation test has been performed by changing a width ratio between the side of each of the metal patterns 201 close to the base substrate 100 and the side of the metal pattern 201 away from the base substrate 100, and in the case that a length of the top line of the trapezoid is half of a length of the base line of the trapezoid, the transmittance and the degree of polarization of the WGP are preferable.

In some embodiments, as shown in FIG. 3, a shape of a cross section of the metal pattern 201 perpendicular to an extending direction of the metal pattern 201 is a triangle, the side of the metal pattern 201 away from the base substrate 100 forms a vertex of the triangle, and the side of the metal pattern 201 close to the base substrate 100 forms a base of the triangle. Optionally, the triangle is an isosceles triangle.

In this embodiment, the cross section of the metal pattern 201 is of a triangle, and the wire grid array of the present disclosure has better transmittance as compared to the wire grid array including the metal patterns 201 each being of a rectangle.

The present disclosure further provides in some embodiments a display device including the above substrate. FIG. 5 is a schematic view showing the display device in some embodiments of the present disclosure, and the display device is a display panel including a color filter substrate 400 and an array substrate, wherein the array substrate is the substrate in some embodiments of the present disclosure.

In addition, as shown in FIG. 6, the present disclosure further provides in some embodiments a method for manufacturing the substrate provided in the embodiments of the present disclosure, including a following step.

Step S601: forming the wire grid array including the plurality of metal patterns arranged in sequence on the base substrate, wherein the width of the side of each of the metal patterns away from the base substrate is smaller than the width of the side of the metal pattern close to the base substrate.

As shown in FIG. 7, forming the wire grid array including the plurality of metal patterns arranged in sequence on the base substrate includes following steps.

Step S701: forming a metal layer 210 on the base substrate 100.

Step S702: coating the metal layer 210 of the base substrate 100 with photoresist 400, exposing and developing the photoresist 400 by using a mask, to form a photoresist-reserved region corresponding to the metal patterns 201 and a photoresist-unreserved region corresponding to other regions.

Step S703: forming the wire grid array 200 including the plurality of metal patterns 201 arranged in sequence in a dry etching process, wherein during the dry etching process, a composition of etching gas being adjusted in a predetermined manner to control a speed of dry etching, to enable that the width W1 of the side of each of the formed metal patterns 201 away from the base substrate 100 is smaller than the width W2 of the side of the metal pattern 201 close to the base substrate 100.

In the above method, the photoresist 400 may be imprinted on the metal layer 210 in a nano-imprinting manner to form strip-shaped patterns of photoresist arranged in sequence.

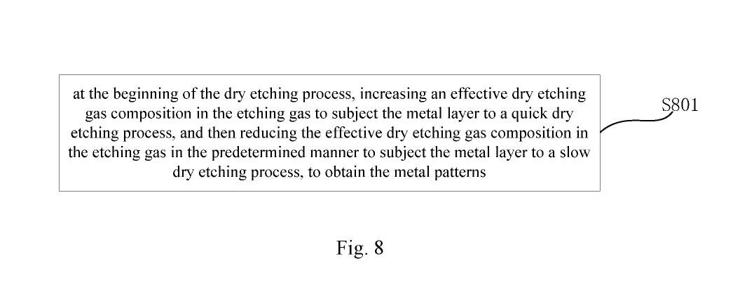

In the above solution, as shown in FIG. 8, during the dry etching process, the composition of the etching gas being adjusted in the predetermined manner to control the speed of the dry etching to enable that the width W1 of the side of each of the formed metal patterns 201 away from the base substrate 100 is smaller than the width W2 of the side of the metal pattern 201 close to the base substrate 100 includes a following step.

Step S801: at the beginning of the dry etching process, increasing an effective dry etching gas composition in the etching gas to subject the metal layer 210 to a quick and effective dry etching process, and then reducing the effective dry etching gas composition in the etching gas in the predetermined manner to subject the metal layer to a slow dry etching process, to obtain the metal pattern 201 as shown in FIG. 2 or 3, wherein the width W1 of the side of the metal pattern 201 away from the base substrate 100 is smaller than the width W2 of the side of the metal pattern 201 close to the base substrate 100.

It should be noted that, although the wire grid array is formed on the base substrate in the dry etching manner in the above solution, in a practical implementation, the wire grid array may also be formed in any one of other manners, such as the nano-imprinting manner.

The above are merely the optional embodiments of the present disclosure, and it should be noted that, a person skilled in the art may make improvements and modifications without departing from the principle of the present disclosure, and these improvements and modifications shall also fall within the scope of the present disclosure.

1. A substrate, comprising a base substrate and a wire grid array formed on the base substrate, wherein the wire grid array comprises a plurality of metal patterns, and a width of a side of each of the metal patterns away from the base substrate is smaller than a width of a side of the metal pattern close to the base substrate.

2. The substrate according to claim 1, wherein a width of the metal pattern increases gradually from the side of the metal pattern away from the base substrate to the side of the metal pattern close to the base substrate.

3. The substrate according to claim 1, wherein
a shape of a cross section of the metal pattern perpendicular to an extending direction of the metal pattern is a trapezoid, the side of the metal pattern away from the base substrate forms a top line of the trapezoid, and the side of the metal pattern close to the base substrate forms a base line of the trapezoid.

4. The substrate according to claim 3, wherein
the trapezoid is an isosceles trapezoid.

5. The substrate according to claim 3, wherein
a length of the top line of the trapezoid is half of a length of the base line of the trapezoid.

6. The substrate according to claim 1, wherein
a shape of a cross section of the metal pattern perpendicular to an extending direction of the metal pattern is a triangle, the side of the metal pattern away from the base substrate forms a vertex of the triangle, and the side of the metal pattern close to the base substrate forms a base of the triangle.

7. The substrate according to claim 6, wherein
the triangle is an isosceles triangle.

8. The substrate according to claim 1, wherein
the width of the side of the metal pattern close to the base substrate is in a range of 30 nm to 100 nm, and the metal patterns are spaced apart from each other at a distance in a range of 60 nm to 200 nm.

9. The substrate according to claim 1, wherein
the substrate is an array substrate or a color filter substrate.

10. A display device comprising the substrate according to claim 1.

11. The display device according to claim 10, wherein
the substrate is an array substrate.

12. A method for manufacturing the substrate according to claim 1, comprising:
forming the wire grid array comprising the plurality of metal patterns on the base substrate, wherein the width of the side of each of the metal patterns away from the base substrate is smaller than the width of the side of the metal pattern close to the base substrate.

13. The method according to claim 12, wherein forming the wire grid array comprising the plurality of metal patterns on the base substrate comprises:
forming a metal layer on the base substrate;
coating the metal layer of the base substrate with photoresist, exposing and developing the photoresist by using a mask, to form a photoresist-reserved region corresponding to the metal patterns and a photoresist-unreserved region corresponding to other regions; and
forming the wire grid array comprising the plurality of metal patterns in a dry etching process, wherein during the dry etching process, a composition of etching gas being adjusted in a predetermined manner to control a speed of dry etching, to enable that the width of the side of each of the formed metal patterns away from the base substrate is smaller than the width of the side of the metal pattern close to the base substrate.

14. The method according to claim 13, wherein during the dry etching process, the composition of the etching gas being adjusted in the predetermined manner to control the speed of the dry etching to enable that the width of the side of each of the formed metal patterns away from the base substrate is smaller than the width of the side of the metal pattern close to the base substrate comprises:
at the beginning of the dry etching process, increasing an effective dry etching gas composition in the etching gas to subject the metal layer to a quick dry etching process, and then reducing the effective dry etching gas composition in the etching gas in the predetermined manner to subject the metal layer to a slow dry etching process, to obtain the metal patterns.

15. The display device according to claim 10, wherein
a width of the metal pattern increases gradually from the side of the metal pattern away from the base substrate to the side of the metal pattern close to the base substrate.

16. The display device according to claim 10, wherein
a shape of a cross section of the metal pattern perpendicular to an extending direction of the metal pattern is a trapezoid, the side of the metal pattern away from the base substrate forms a top line of the trapezoid, and the side of the metal pattern close to the base substrate forms a base line of the trapezoid.

17. The display device according to claim 16, wherein
the trapezoid is an isosceles trapezoid.

18. The display device according to claim 16, wherein
a length of the top line of the trapezoid is half of a length of the base line of the trapezoid.

19. The display device according to claim 10, wherein
a shape of a cross section of the metal pattern perpendicular to an extending direction of the metal pattern is a triangle, the side of the metal pattern away from the base substrate forms a vertex of the triangle, and the side of the metal pattern close to the base substrate forms a base of the triangle.

20. The display device according to claim 19, wherein
the triangle is an isosceles triangle.
